(19) United States
(12) Patent Application Publication
(10) Pub. No.: US 2002/0144664 A1
(43) Pub. Date: Oct. 10, 2002

(54) Heating of fuels

(75) Inventor: Charles W. Haldeman III, Concord, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Supercritical Combustion Corporation, Woburn, MA

(21) Appl. No.: 09/829,016

(22) Filed: Apr. 9, 2001

(51) Int. Cl. F02B 33/44

(52) U.S. Cl. 123/25 B; 60/606

(57) ABSTRACT

A method for forming a water/fuel mixture includes heating a water stream to a temperature of at least about 260° C. (500° F.) and a pressure of at least about 150 psig (10.2 atmospheres gauge) and combining it with a fuel stream, optionally heated to a temperature less than about less than about 177° C. (350° F.). Preferably, the energy for heating the water stream and optionally the fuel stream or, for further heating the water/fuel mixture is recovered from a hot stream generated in a turbine system or diesel engine system. A combustion system suitable for forming the water/fuel mixture includes a combustor, means for heating a stream of water, means for combining the stream of heated water with a fuel stream having a temperature less than about 177° C. (350° F.), to form the mixture and means for directing the mixture to the combustor. Preferably, the combustion system includes a turbine system or a diesel engine.

### BACKGROUND OF THE INVENTION

It is desirable to preheat fuel for a variety of reasons or applications. Water/fuel mixtures are particularly advantageous for some applications, particularly if they are in a supercritical state. In combustion systems, supercritical water-fuel mixtures provide both good performance and reduced NOx and particulate matter generation. Supercritical water/fuel mixtures can be formed at a temperature and/or pressure near or above the critical point of the water/fuel mixture. Many of the advantages of supercritical water/fuel mixtures also can be realized employing a mixture somewhat below the critical pressure of the mixture (referred to as a sub-supercritical mixture). Such a mixture has a temperature being at least the greater of about 250° C. (482° F.) and the boiling point temperature of water at the mixture pressure.

In one approach to generate a supercritical or sub-supercritical water/fuel mixture, each fuel is separately heated to its supercritical temperature. The separately heated fluids are then mixed or blended together. However, most liquid hydrocarbon fuels undergo severe cracking and carbonization if heated above about 177° C. (350° F.). This fouls heat exchanger surfaces and limits the temperature to which it is feasible to heat the fuel.

In another approach, the fluids, generally at ambient temperature, are first mixed together. The resulting mixture is then heated to produce a supercritical or sub-supercritical water/fuel mixture. However, the two materials have very different viscosities and the flow of the resulting two-phase mixture through a conventional apparatus is associated with forming fuel slugs, thereby resulting in unsteady flow and ejection. Furthermore, the fuel generally moves more slowly than water through any practical device, takes up a larger fraction of the volume than expected from the feed fuel to water ratio, and tends to coat heat transfer surfaces.

To achieve a water/fuel supercritical mixture of, for example, about 399° C. (750° F.), a significant amount of heat has to be added. When a pure liquid is heated at a pressure below it's critical pressure, it changes phase at its boiling point. (This boiling point is a temperature range for a mixture). Sensible heat needs to be put into the system to bring the liquid up to the boiling point and additional heating to provide the “latent heat of vaporization” is needed for the change of phase to occur (i.e., to convert the liquid into a gas), which is sometimes greater than the sensible heat. When a liquid is heated at a pressure above its critical pressure, no phase change takes place. However, the heat input required to achieve the supercritical state is considerably greater than that estimated from its low temperature heat capacity. Indeed the enthalpy of water at 4000 psia and 750° F. is almost as high as steam at lower pressure, which has gone through the phase change. It has been found that a significant extra amount of heat (beyond that expected from it's low heat capacity) has to be added to fuel to get it to the supercritical mixture state. For example, to achieve a water/fuel supercritical mixture temperature of about 399° C. (750° F.), even when the fuel is heated to about 177° C. (350° F.), the water needs to be heated to a temperature of about 593° C. (1100° F.) . Operating at such a temperature requires high temperature alloys and/or thick apparatus walls to contain the water. Also, heating to about 593° C. (1100° F.) is expensive under commercial conditions, the only practical heat sources being the radiant section of a firebox and electrical heat.

The production of a critical, supercritical or sub-critical water/fuel mixture requires energy to bring the water and fuel from ambient temperatures to the temperature and pressure characteristic of the critical, supercritical or sub-supercritical range for that mixture. While electrical energy can be used to provide this heat, it adds to the operating and capital cost.

Therefore a need exists to provide methods for generating a critical, supercritical or sub-supercritical water/fuel mixture that reduce or minimize the above-mentioned problems.

### SUMMARY OF THE INVENTION

The invention generally is directed to a method of forming a mixture of fuel and water. The method includes heating and pressurizing a stream of water to a temperature of at least about 260° C. (500° F.) and a pressure of at least about 150 psig to form a stream of heated and pressurized water. The stream of heated pressurized water is combined with a fuel stream at a temperature of less than about 177° C. (350° F.), thereby forming the mixture of fuel and water.

In one embodiment of the invention, the water/fuel mixture is formed by recovering heat from a hot stream generated in a turbine system. For example, heat can be recovered from hot compressed air generated by a compressor, from hot combustion products generated in combustion or from hot exhaust generated by a turbine. Recovered heat is transferred to a water stream. The water stream at a temperature of at least about 260° C. (500° F.) then is combined with a fuel stream to form a water/fuel mixture. Optionally, the fuel stream also is heated, prior to mixing with the heated water stream, generally to a temperature not exceeding about 177° C. (350° F.). Recovered heat also can be employed to further heat the water/fuel mixture, for example, to a temperature of about 500 to 850° F. In a preferred embodiment, the water/fuel mixture is employed in a combustion system or device.

In another embodiment of the invention, the water/fuel mixture is formed by recovering heat from a hot stream generated from the exhaust of a diesel engine system.

The water is pressurized to at least about 150 psig, and it is generally preferred to pressurize the water and fuel streams to approximately the same pressure. In both the turbine system and diesel engine system embodiments, the water and fuel streams are pressurized to at least about 150 psig, which is a level generally sufficient for effective passage thereof through the conduits utilized to facilitate the heating and/or combining thereof, as well as sufficient to provide for adequate conveyance of any residual oil phase into the combustion apparatus . Most preferably the components of the mixture are pressurized to at least about 200 psig or even to a higher pressure level which is sufficient for injection of the water/fuel mixture into a combustion device. Additionally, even higher pressure to help assure appropriate mixing with separately injected air steams. For turbines the fuel mixture injection pressure would typically be above about 150-200 psig) and for diesel engines would typically be above about 500 psig, with pressures above about 5,000 psig not normally necessary or desirable in either turbine of diesel applications.

The invention also is directed to a combustion system suitable for combusting the water/fuel mixture. The system includes a combustor, means for heating a stream of water to a temperature of at least about 260° C. (500° F.) to form a heated stream of water. The system also includes means for combining the stream of heated water with a fuel stream, the means including a fuel stream having a temperature less than about 176° C. (350° F.) at combination with the heated water, to thereby form a mixture of fuel and water, and means for directing said mixture to the combustor for combustion.

In one embodiment of the invention, the combustion system includes a turbine system. In turn, the turbine system includes a compressor, a power turbine and a combustor. Preferably, the water/fuel mixture is combusted with an oxidant in the combustor.

The invention has many advantages. For example, the invention provides an economical method that has fewer processing problems than separately heating a fuel stream to a final temperature or combining a water and fuel streams at ambient temperature and then heating the mixture. The invention also provides energy recovery methods suitable for a turbine system that utilizes a water/fuel mixture somewhat below, at or above its critical point.

### BRIEF DESCRIPTION OF THE DRAWINGS

FIG. 1 is a schematic diagram of an arrangement for forming a water/fuel mixture of the invention.

FIG. 2 depicts a turbine system of the invention in which a heat recovery device is positioned between the compressor and the combustor.

FIG. 3 depicts turbine system of the invention in which a heat recovery device is positioned between the combustor and the power turbine.

FIG. 4 depicts a turbine system of the invention in which a heat recovery device is positioned in the exhaust gas stream of the power turbine.

FIG. 5 depicts a turbine system wherein a supplemental heating device also is used.

FIG. 6 depicts a diesel engine system of the invention in which a heat recovery device is positioned in the engine exhaust system.

### DETAILED DESCRIPTION OF THE INVENTION

The features and other details of the invention, either as steps of the invention or as combinations of parts of the invention, will now be more particularly described with reference to the accompanying drawings and pointed out in the claims. The same numeral present in different figures represents the same item. It will be understood that the particular embodiments of the invention are shown by way of illustration and not as limitations of the invention. The principle features of this invention may be employed in various embodiments without departing from the scope of the invention.

The invention generally is related to methods of producing water/fuel mixtures at or near the critical state. The water/fuel mixtures of the invention are useful in combustion processes where they are combusted with an oxidant, such as air. In a preferred embodiment, the water/fuel mixtures of the invention are employed in gas or combustion turbine systems, or in diesel engine systems.

Suitable fuels that are combined with water to form the water/fuel mixtures of the invention include, but are not limited to, hydrocarbon fuels, in particular distillate fuels such as, for instance, diesel (e.g., No. 2 fuel oil), kerosene (e.g., No. 1 fuel), methane, residual (e.g., No. 6 fuel), natural gas and gasoline, as well as non-hydrocarbon fuels, such as, for example, alcohols. Fuels that are employed in turbine systems and that do not result in significant residue when burned are preferred.

The water/fuel mixtures formed by the methods of the invention are somewhat below, at or above the critical point of the mixture. The critical pressure is the pressure required to liquefy a vapor at the critical temperature. The critical temperature is the temperature above which a vapor cannot be liquefied, regardless of pressure. The point at which the temperature and pressure have their critical value is known as the critical point. Above the critical point, there is no distinction between gas and liquid phases. Fluids beyond the critical point are known as supercritical fluids.

Critical points can be obtained from the literature or determined experimentally, as known in the art. For example, phase diagrams, showing the critical point, are available in the literature (e.g., Volumetric and Phase Behavior of Hydrocarbons, Gulf Publishing Company, 1949) or can be generated experimentally for pure substances or mixtures of substances.

The critical point of water is about 374° C. (705° F.) and 3221 psi (220 atmospheres). Fuels generally include compounds having a wide range of molecular weights and as such do not have a well-defined critical temperature. The addition of a liquid hydrocarbon or mixture of liquid hydrocarbons to water results in an altering of the critical temperature and critical pressure of the water/fuel mixture compared to the individual components. For example, the critical temperature of a 50/50 weight percent mixture of No. 2 hydrocarbon fuel and water is about 363° C . Generally, the critical temperature of a water/fuel mixture is approximately equal to the weighted average of the critical temperatures of each of the fluid species and is generally in the range between about 250° C. and 600° C., depending upon the molecular composition and percentage of hydrocarbon. However, as in the above cited 50/50 mixture (or other mixtures of two chemically dissimilar mixtures, the critical temperature of the mixture can be significantly lower than the simple weighted average due to the entropy change resulting from the chemical bonds formed between the components.

Often, mixtures of one or more liquid hydrocarbons and water have a lower critical temperature than that of pure water. For example, the critical point of a mixture of 25 weight % water and 75 weight % No. 2 fuel oil is about 362° C. (684° F.) at 3300 psi. As previously noted, a 50/50 weight percent mixture of water and No. 2 fuel oil has a critical temperature of about 363° C.

Supercritical water/fuel mixtures are disclosed in U.S. Pat. No. 6,010,544, issued on Jan. 4, 2000 to Haldeman, et al., which is incorporated herein by reference in its entirety.

Many of the advantages of supercritical water/fuel mixtures also can be obtained with sub-critical water-fuel mixtures. Sub-critical water/fuel mixtures are disclosed in co-pending U.S. patent application No. 09/359,509, filed Jul. 23, 1999, which is incorporated herein by reference in its entirety.

In a preferred embodiment, the water/fuel mixture formed by the method of the invention is at a temperature at or above about 362° C. (684° F.).

Water/fuel mixtures can be prepared by the method of the invention as follows. Water is separately heated to a temperature of above about 204° C. (400° F.), most preferably above about 315° C. (600° F.). In a preferred embodiment, water is heated to a temperature that does not exceed about 427° C. (800° F.). Water also can be heated above 427° C. (800° F.), for example to about 538° C. (1000° F.), and even to about 593° C. (1100° F.).

In one embodiment of the invention, fuel is not separately heated prior to being combined with the heated water. For example, fuel is provided at ambient temperature (i.e., the temperature will be that of the surrounding environment). In some cases (e.g., fuels stored outside in colder climates) the ambient temperature may be considerably lower than standard conditions (e.g., 70° F.) and may be heated to facilitate pumping or of the fuel. In the practice of the invention, particularly for #1 (kerosene), #2 (diesel),, #6 (residual) and gasoline, the fuel is heated to a temperature no greater than about 177° C. (350° F.).

The pressure of each stream is selected to ensure that the water stream and, the fuel stream are forced through the conduits and any associated heating means. An essentially constant pressure process is preferred, to minimize pumping difficulty and power requirements. Most preferably, the pressure is sufficiently high to facilitate the injection of the water/fuel mixture into the selected combustion. Typically, the water is heated at a pressure between about 3200 pounds per square inch gauge (psig) and about 4000 psig. Generally, the fuel stream is preferably at the same or at a similar pressure. In a preferred embodiment, the water and fuel streams are each pressurized to essentially the same pressure, for example in the range of from about 3200 to about 5000 psi.

Pressures such as those employed herein can be obtained as known in the art. Suitable equipment includes compressors and pumps.

The heated water is then combined with the unheated, (i.e., ambient temperature), or heated fuel. The ratio of fuel to heated water used to form a water/fuel mixture in the sub-critical, critical or supercritical state, can be adjusted to obtain a mixture having a selected temperature, as determined by the temperature of the individual streams forming the mixture (depending upon the temperature to which each separate stream has been heated). For example, a mixture having a temperature of about 399° C. (750° F.) and including 50 wgt. % diesel fuel and 50 wgt. % water can be formed by combining 50 wgt. % diesel fuel at 177° C. (350° F.) and 50 wgt. % water at about 593° C. (1100° F.), both having been previously pressurized to 4000 psi.

Means for controlling flow rates of the fuel and heated water streams to form a desired water-to-fuel ratio are known in the art. Examples include flow control loops and positive displacement pumps.

The fuel and water streams are combined by a suitable means. Examples of suitable means include introduction into a pipe tee, a static mixer, a dynamic mixer or by some other suitable mixing means or method known in the art for combining fluid streams.

Optionally, the water/fuel mixture is further heated. In embodiments in which the mixture is heated to a supercritical state or to a relatively high temperature sub-supercritical state, it is preferable to initial heat the water stream, prior to mixing with the fuel, to about the temperature desired for the ultimate mixture and thereafter further heating the mixture to the desired final temperature. This approach is more efficient in that the heat exchange surface is minimized and the highest temperature of the heat exchanger metal is minimized (e.g., thus allowing the use of lower cost heat exchangers). Such mixtures generally have final temperatures in a range of between about 399° C. (750° F.) and about 427° C. (800° F.). When a relatively low temperature sub-supercritical mixture is being prepared, it is generally preferable to heat the water prior to mixing and not provide supplemental heating the final mixture. Generally, the water/fuel mixture can be heated without significant fouling as long as the heated surfaces containing the mixture do not exceed about 454° C. (850° F.).

Separately heating the water stream and optionally the fuel stream and/or further heating the resulting water/fuel mixture can be by any suitable means known in the art. In a preferred embodiment, heating of either or both of the individual fuel and water streams, and/or further heating the resulting mixture is conducted by use of heat derived directly or indirectly from a combustion process employing at least a portion of the heated fuel/water mixture previously formed. The means for heating and means pressurizing of the water and/or fuel streams are generally individual units, which normally would be integrally connected (e.g., by piping), however, a single unit which provides both heating and pressurizing may be used.

It is most preferred that the water stream be in the liquid or supercritical state (as opposed to the gaseous state) when heated. When the water phase is maintained as a liquid until at or near supercritical or sub-supercritical conditions, less heat needs to be put in and/or it can be put in more cost-effectively at a lower temperature. For example, to produce a 0.43 lb water/1.0 lb fuel mixture, if one initially heated water to produce 536° F. psig saturated steam, mixed it with fuel at 68° F. and then further heated the steam/fuel mixture to 707° F., approximately 19% more heat would be required, compared to an approach according a preferred practice of this invention in which the liquid would be maintained in the liquid state during the heating of the liquid water to a temperature of 707° F. at 4000 psia and then further heating the mixture to 707° F. Furthermore, when heating liquid water, the heat can be cost-effectively obtained from countercurrent exchange with exhausted combustion products.

In one embodiment, for example, a significant amount of heat is transferred from a turbine system, such as heat resulting from air compression or from combustion. Further the temperature of hot gas introduced to a power turbine typically is limited to a range of between about 927° C. (1700° F.) and about 1427° C. (2600° F.), due to the metallurgy of the compressor nozzle and turbine blades. In some turbine systems, such as, for instance, high-pressure multi-stage systems, heat typically is removed between compression stages through use of one or more intercoolers. In other systems, such as, for example, low-pressure ratio turbines, wherein less heat is generated in the compression stage, a heat exchanger or regenerator typically is employed to remove heat from the turbine exhaust and the heat is then employed to heat the compressed air prior to its introduction into the combustor. In still other applications, such as, for example, applications commonly referred to as a combined cycle turbines, turbine exhaust gas is employed to boil water under pressure to run associated steam turbines for power generation.

In preferred embodiments of the invention, heat is recovered from one or several points or locations in a turbine system and employed to heat the water stream. Optionally, or alternatively, heat transferred from a turbine system can be employed to heat the fuel stream and/or to further heat the resulting water/fuel mixture. Suitable turbine systems include, for example, single-stage turbines, multi-stage turbines and combined cycle turbines. Several streams can be heated or further heated through the heat recovery/heat transfer arrangements disclosed herein. In a preferred configuration, the extracted heat is employed first to further heat a water/fuel mixture to or near its critical state, then to heat a water stream prior to its admixture with fuel, and lastly to heat the fuel. In turn, the water/fuel mixture can then be combusted with an oxidant, such as air, to operate the turbine. In other prefer embodiments, the combustion system is a diesel engine system, most preferably in which heat used to heat the water/fuel mixture is recovered from the combustion exhaust,. Other suitable combustion systems, e.g., boilers and incinerators, are also suitable.

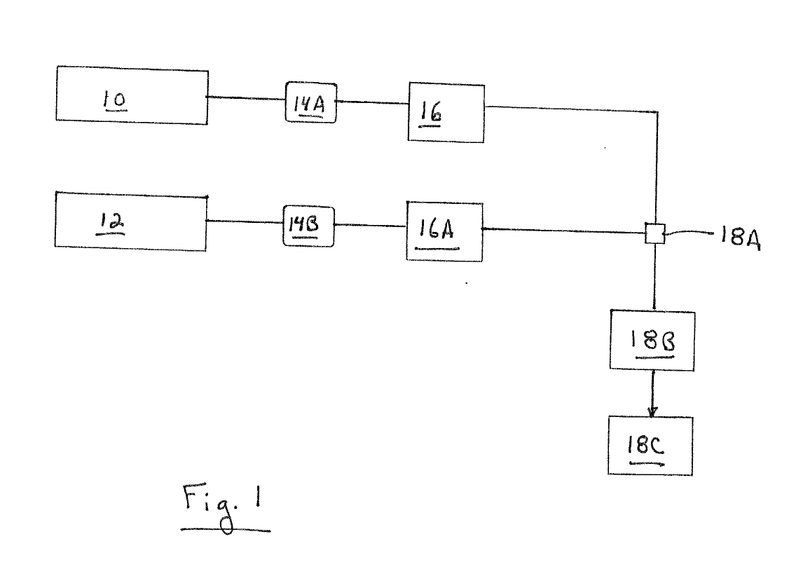

FIG. 1 is a schematic diagram of an arrangement for forming a water/fuel mixture of the invention. As shown in FIG. 1, fuel from fuel source 10 and water from water source 12 are pumped by means of pump 14A and pump 14B respectively through the system ultimately to a combustor (not shown) . The fuel stream may be heated to a temperature less than 350° F. in optional heater 16 or piped directly to mixing tee 18A. The water stream is heated to a temperature of at least 500° F. in heater 16A and is then piped directly to mixing tee 18A, wherein it is mixed with the fuel stream. The combined water/fuel stream may be mixed in optional mixer 18B (if further mixing of the mixture is desired) or piped directly to optional heater 16B (if further heating of the mixture is desired). The water/fuel mixture is then piped to a combustor (not shown), such a turbine or diesel engine.

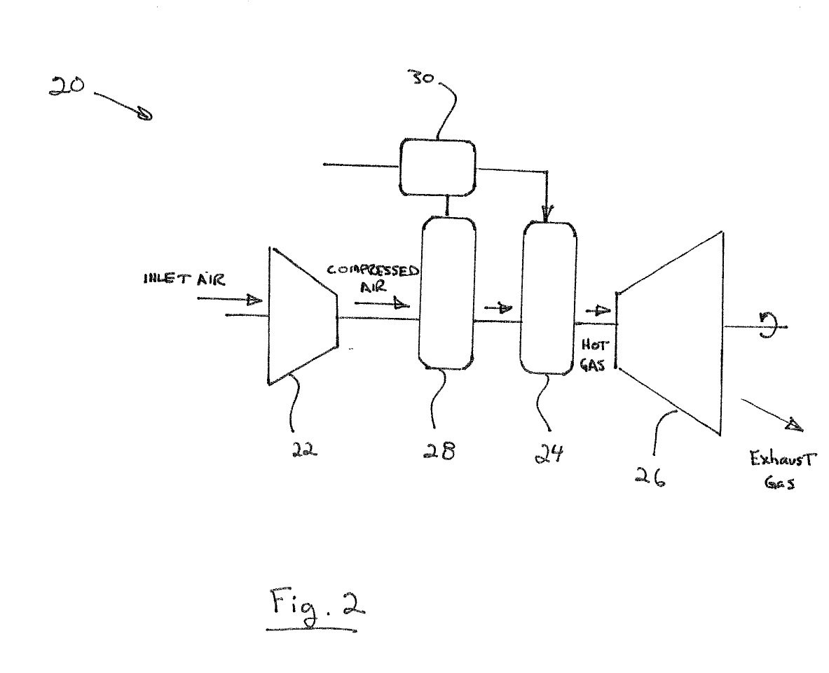

FIG. 2 is a schematic diagram of a heat recovery arrangement of one embodiment of the invention. As shown in FIG. 1, turbine system 20 includes compressor 22, combustor 24 and turbine 26. Preferably, turbine 26 is a high-pressure turbine, i.e., a turbine that operates at pressures higher than about 10 atmospheres (about 132 psig). Inlet air from a source, not shown, is compressed in compressor 22. The temperature of the compressed air generated by compressor 22 generally ranges from about 730° F. (388° C.) to about 1030° F. (554° C.). Heat recovery device 28 extracts heat from hot compressed air exiting compressor 22. Heat transfer device 30 transfers the heat recovered from the hot compressed air to one of the streams described above, for example, the water stream, optionally the fuel stream or to further heat the water/fuel mixture. Heat transfer device 30 is employed to further heat the water/fuel mixture, which is then directed to combustor 24.

Heat recovery device 28, is, for example, a suitable heat exchanger. More than one heat recovery device 28 can be employed. In one embodiment of the invention, heat recovery device 28 employs an intermediate heat transfer fluid to extract heat from the hot compressed air exiting compressor 22.

Suitable intermediate heat transfer fluids include, but are not limited to, Dowtherm™, Therminol™, Terminol™ and many others. The intermediate heat transfer fluid is then directed to heat transfer device 30, which can be for example, a heat exchanger. Heat transfer device 30 further heats the water/fuel mixture or, in other embodiments, heats the water stream and/or, optionally, the fuel stream. More than one heat transfer device 30 can be employed.

Examples of heat transfer devices that can be employed to practice the invention include, but are not limited to shell and tube heat exchangers, finned tube, screw fin tube and other types of heat exchangers, such as are known in the art. Other equipment, such as recuperators and regenerators also can be employed to recover and transfer heat.

In an alternative embodiment, not shown, the heat recovery/transfer device is a single integrated device in which the water/fuel mixture or one of the components thereof is itself a heat transfer fluid. For instance, hot compressed air can be fed to one side, such as the tube side, of a shell-and-tube heat exchanger, while the stream, e.g., water or fuel to be heated, or the water/fuel mixture to be further heated, is introduced to the opposite side, i.e., the shell side of the heat exchanger. Co-current and counter current configurations can be employed, with a counter-current arrangement being preferred. More than one integrated heat recovery/heat transfer device can be employed.

Optionally, supplemental heating means, e.g., electrical heating, not shown in FIG. 2, can be employed to further heat the water/fuel mixture or any components thereof.

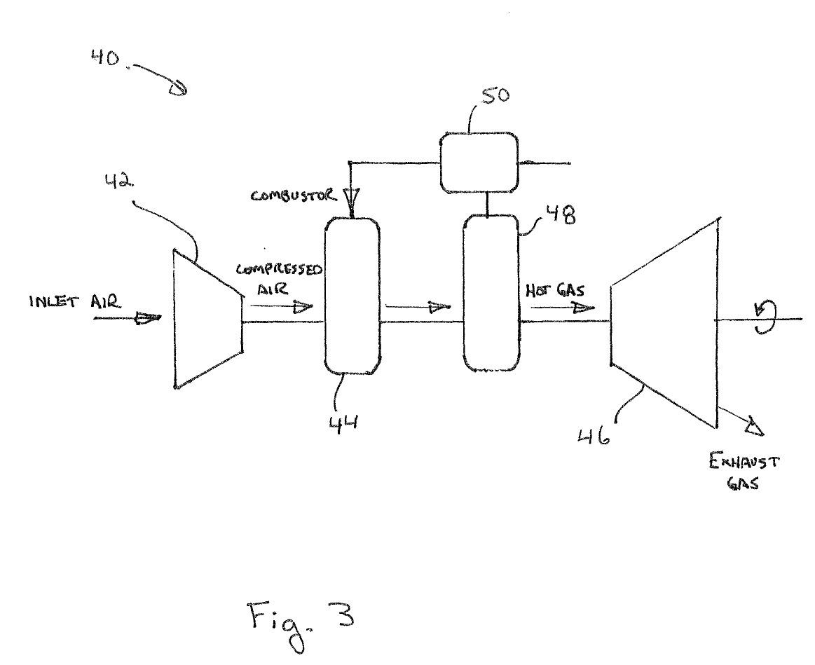

FIG. 3 is a schematic diagram of yet another embodiment of the invention, wherein turbine system 40 includes compressor 42, combustor 44 and turbine 46. Turbine 46 can be a low or a high-pressure turbine. Hot combustion products exiting combustor 44 generally have a temperature ranging from about 1800° F. (592° C.) to about 2600° F. (1427° C.). Heat recovery device 48, essentially as described above, recovers heat from the hot combustion products generated in combustor 44. Heat is transferred, for instance, to further heat the water/fuel mixture, in heat transfer device 50, essentially as described above. The water/fuel mixture is then fed to combustor 44.

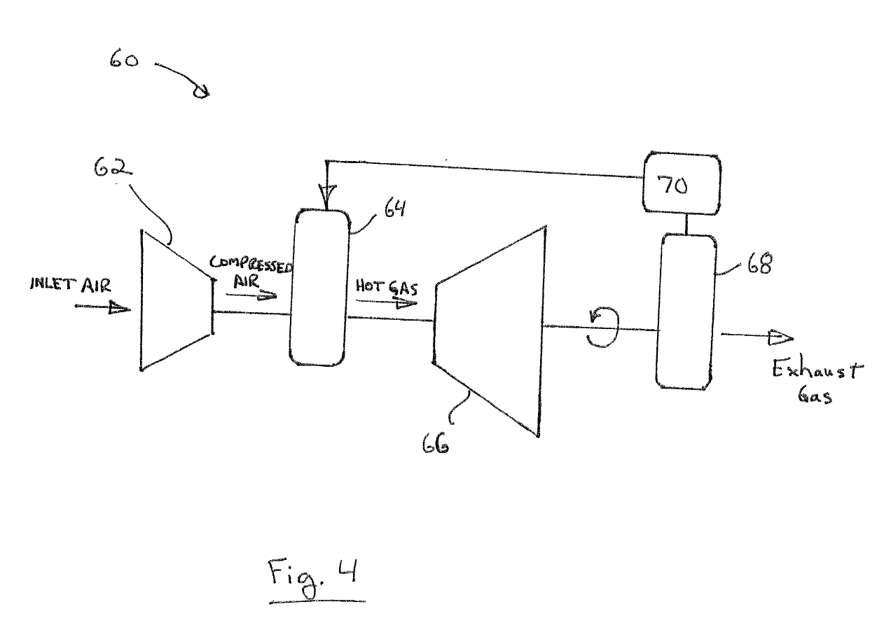

FIG. 4 is a schematic diagram of another embodiment of the invention, wherein turbine system 60 includes compressor 62, combustor 64 and turbine 66. Preferably, turbine 66 is a low pressure turbine, i.e., less than about 10 atmospheres absolute (132 psig). Heat is recovered from hot exhaust generated by turbine 66 in heat recovery device 68, essentially as discussed above. Generally, the temperature of the hot exhaust produced by turbine 66 ranges from about 730° F. (388° C.) to about 1110° F. (593° C.). The water/fuel mixture, is further heated in heat transfer device 70, essentially as described above, and then combusted in combustor 64.

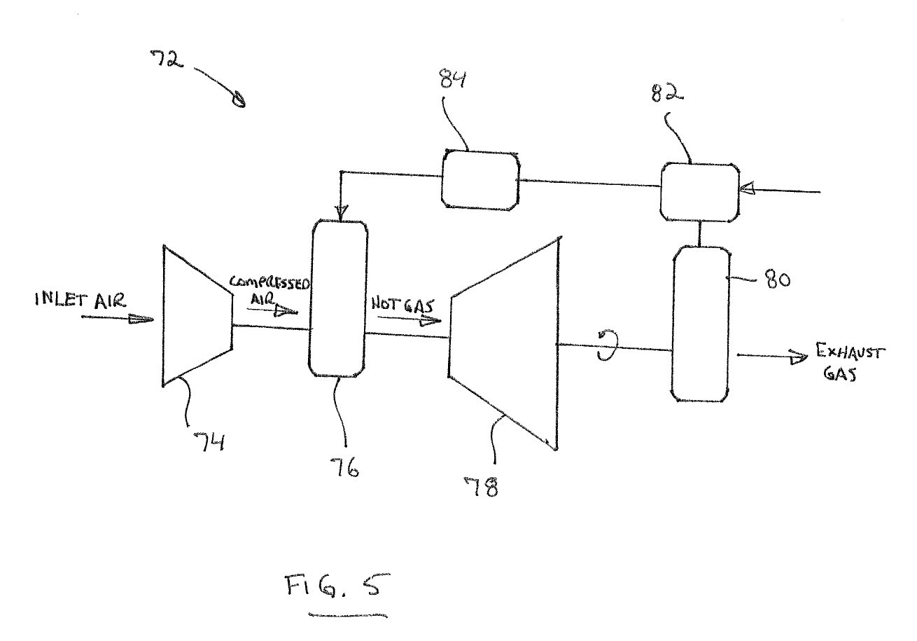

FIG. 5 is a schematic diagram of a heat recovery arrangement which employs supplemental heating and is similar, in all other respects, to the arrangement shown in FIG. 4. As shown in FIG. 5, turbine system 72 includes compressor 74, combustor 76 and turbine 78. Turbine 78 can be a low or a high-pressure turbine, and heat is recovered from hot combustion products exiting combustor 76 via heat recovery device 80. Heat transfer to the water/fuel mixture, or any component thereof, takes place in heat transfer device 82 and further heating is conducted by supplemental heating device 84. Example of suitable supplemental heating device 84 includes, a heater, electric current passed through the conveying pipe, electrical resistance bayonet heaters and Auxiliary direct-fired furnaces.

The water/fuel mixture of the invention also can be formed in a combustion system which includes a combustor which is not part of a turbine system, such as, for instance, a burner employed in a furnace, boiler or another combustion device as known in the art. The system also includes means for heating a stream of water to a temperature of at least about 315° C. (600° F.). Heat exchangers, such as described above, heaters or other heating means can be employed, as known in the art. The heated water stream, having a pressure of at least about 218 atmospheres (3200 psig) is combined with a fuel stream having a temperature less than about 176° C. (350° F.) at combination with the heated water in a mixing device, essentially as described above. The resulting mixture of fuel and water is directed via suitable conduits to the combustion device.

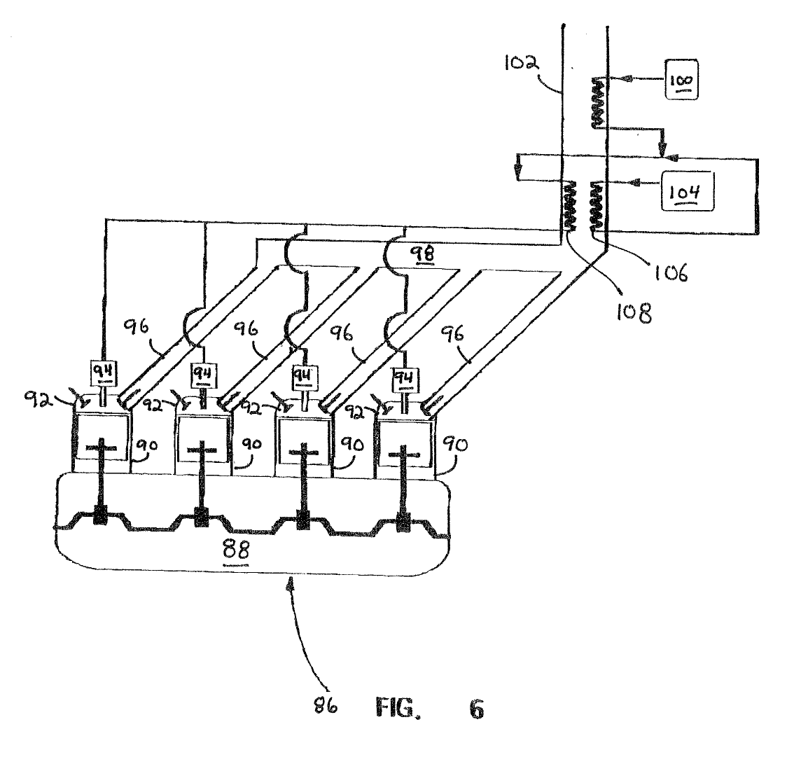

FIG. 6 is a schematic diagram of another embodiment of the invention for a diesel engine system 86. The diesel engine system consists in a block 88, cylinders 90, cylinder heads 92, injectors 94, exhaust headers 96 and exhaust pipe 98. Pressurized fuel 100 is passed through a heat exchanger 102 at the cold end of the exhaust pipe 86. Pressurized water 104 is passed through another exchanger 106 upstream of exchanger 102. The heated fuel and water are combined and passed through heat exchanger 108 at the same axial location in the exhaust pipe as exchanger 106. Effluent from this mixture is passed to the diesel injectors 94.

The invention is further described through the following examples which are provided for illustrative purposes and are not intended to be limiting.

Exemplification

### EXAMPLE 1

In a laboratory sized unit for delivering 200 gm/min of fuel oil and 200 gm/min of water to a supercritical fuel burner, a heating unit composed of 5 heavy wall pipes was used with resistive cartridge heaters inside the pipes. The first pipe (first stage) contained two resistive heaters of 5 kilowatts total power. These were controlled using a proportional controller with a thermocouple at the discharge end of the pipe which fed directly into the next two pipes which contained 6 kilowatts of heaters and were separately controlled by a thermocouple at the end of the 3rd pipe. At this point the junction tee and the mixture proceeded through the last two pipes which contained 3.5 kilowatts of additional heaters that were controlled by a thermocouple at the heater outlet. This was connected directly to the burner by an insulated pipe. During operation the first stage steam controller was set to 600° F., the second stage to 800° F., and the final stage to 800° F. This produced a mixture at the burner nozzle at 4000 psi and 750° F.

Additional mixtures were prepared with the heater unit operated at water flows of 0.75, 1.0, and 1.1 times the oil flow rate.

### EXAMPLE 2

FIG. 1 is a schematic diagram of an arrangement employed to form a water/fuel mixture in one embodiment of the invention. Shown in FIG. 1 is fuel source 10 and deionized water source 12. Diesel fuel at ambient temperature and a rate of 4000 lb/hr is directed to pump 14A where it is pressurized to a pressure from about 3200 to about 5000. Optionally, fuel is then directed to heater 16 where it can be heated to about 350° F. From optional heater 16, fuel is directed to optional mixing device 18A.

Deionized water at the rate of 2000 lb/hr from deionized water source 12 is directed to pump 14B where it is compressed to a pressure of about 4000 psig. The pressurized water stream is then directed to heat exchanger 16A which is 10 sq. ft. 316SS shell-and-tube heat exchanger heated by 800° F. off gas from a combustion turbine expander, not shown. The water stream exits heat exchanger 16A at about 700° F. and is mixed with 4000 lb/hr of diesel fuel in static mixer 18B. For fuel at ambient temperature (in this case about 70° F.), the resulting mixture has a temperature of about 433° F. The resulting two phase mixture is further heated in heat exchanger 18C which is a 500 sq. ft. 316 SS shell-and-tube heat exchanger heated by 800° F. off-gas from the same combustion turbine, not shown. The resulting 700° F. mixture is passed to the combustor of the turbine system, not shown.

### EXAMPLE 3

In an arrangement similar to that shown in FIG. 1, deionized water at the rate of 2000 lb/hr is pumped to 200 psig pressure and directed to a 10 sq. ft. 316SS shell and tube exchanger heated by 700 psig steam. The water exits at 450° F. and is directed to a 200 sq. ft. 316SS shell and tube exchanger heated by 800° F. off-gas from a combustion turbine expander. The water exits the exchanger at 700° F. and is mixed with 4000 lb/hr of diesel fuel in a static mixer. The resulting temperature is 433° F. This two-phase mixture is passed to the combustor of this turbine.

### EXAMPLE 4

In another experiment, water at 700° F. is passed to a direct-fired furnace and flowed through 100 ft. of 1@ Schedule 80 Inconel pipe set behind a radiation barrier. The water exits at 1300° F. and is mixed with 4000 lb/hr diesel fuel at ambient temperature. The mixed temperature is found to be 700° F. The supercritical mixture is passed to a combustion operation.

### EXAMPLE 5

A turbine, operating at 4 atmospheres (44 psig), is fed 140 lb/hr diesel fuel and 210 lb/hr distilled water. Air to combustion is controlled at 5355 lb/hr to maintain a combustion temperature of 1800° F. The combustion gases are expanded through a turbine with 85% efficiency to a final temperature of 1350° F. These gases are contacted with the mixed fuel/water stream in an heat exchanger with screw fin tubes made of 316 stainless steel and having 7.5 sq. ft. internal surface. The fuel/water stream enters at 680° F. and reaches 750° F. The gases are cooled to 1307° F. The cooled gases are then contacted with the distilled water pumped to 4000 psig and entering at 70° F. in a 316 stainless steel screw fin tube exchanger of inside surface area 15 sq. ft. The water is heated to 750° F. and the gases cooled to 1188° F. The 750° F. distilled water is mixed with cold (70° F.) diesel fuel to produce a 680° F. mixture. The 750° F. fuel/water mixture is a supercritical mixture which is then passed to the turbine combustor for mixing with the air and subsequent combustion.

### EXAMPLE 6

A turbine operating at 10 atmospheres (132 psig), is fed 140 lb/hr diesel fuel and 210 lb/hr distilled water. Air to combustion is controlled at 4550 lb/hr to maintain a temperature to the expander of 1800° F. Combustion gases at a temperature of 1970° F. are contacted with the mixed fuel/water stream in a tubed heat exchanger made of Inconel and having 6 sq. ft. internal surface. The fuel/water stream enters at 680° F. and reaches 750° F. The air is cooled to 1932° F. The air is then contacted with the distilled water pumped to 4000 psig and entering at 70° F. and 4000 psig in shell-and-tube Inconel heat exchanger of inside surface area 1.6 sq. ft. The water is heated to 750° F. and the air cooled to 1800° F. The 750° F. distilled water is mixed with cold (70° F.) diesel fuel to produce the 680° F. mixture. The 680° F. fuel/water mixture is a sub-supercritical mixture which is then passed to the turbine combustor for mixing with the air and subsequent combustion.

Equivalents

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of forming a mixture of fuel and water, comprising the steps of:
a) heating a stream of water to a temperature of at least about 260° C. (500° F.) to thereby form a stream of heated water, said stream of water having a pressure of at least about 150 psig (10.2 atmospheres gauge), and
b) combining the stream of water with a fuel stream, said fuel stream having a temperature less than about 177° C. (350° F.), thereby forming said mixture of fuel and water.

2. The method of claim 1, wherein the stream of water is in the liquid or supercritical state during said heating step.

3. The method of claim 1, wherein the relative amounts of water and fuel cause the resulting mixture to have a temperature of at least about 204° C. (400° F.), and further including the step of heating the mixture to a temperature of at least about 362° C. (684° F.).

4. The method of claim 1, wherein the water stream heated to a temperature sufficient to cause the mixture of fuel and water to have a temperature of at least about 362° C. (684° F.).

5. The method of claim 1, wherein the water stream is heated to a temperature of at least about 426° C. (800° F.)

6. The method of claim 1, wherein the water and fuel streams are pressurized to a level sufficient for injection of the water/fuel mixture into a combustion device.

7. The method of claim 1, wherein the water and fuel streams are each pressurized to greater than about 200 psig.

8. The method of claim 7, wherein the water and fuel streams are each pressurized to less than about 5000 psig.

9. The method of claim 1, wherein the fuel and water streams are combined in a relative amount to cause the resulting mixture to have a temperature of at least about 362° C. (684° F.).

10. The method of claim 1, further including the step of heating the mixture of fuel and water to a temperature of at least about 362° C. (684° F.).

11. The method of claim 1, wherein the fuel is hydrocarbon fuel.

12. The method of claim 8, wherein the hydrocarbon fuel is selected from the group consisting of #2 (diesel), #1 (kerosene), #6 (residual), and gasoline.

13. The method of claim 1, further including the step of injecting the mixture into a combustion device.

14. The method of claim 1, whereby the water stream is heated by transferring heat from a turbine system.

15. The method of claim 1, whereby the water stream is heated by transferring heat from a diesel engine.

16. A combustion system, comprising:
a) a combustor;
b) means for heating and pressurizing a stream of water to a temperature of at least about 260° C. (500° F.) and a pressure of at least about 150 psig (10.2 atmospheres gauge) to thereby form a heated and pressurized stream of water;
c) means for combining the stream of heated water with a fuel stream, said means including a fuel stream having a temperature less than about 177° C. (350° F.) at a point of combination with the heated water, to thereby form a mixture of fuel and water; and
d) means for directing said mixture to the combustor for combustion.

17. The combustion system of claim 16, further including a turbine system, said turbine system including at least one compressor and at least one power turbine, and wherein said means for heating the stream of water includes means for transferring heat from combustion of a previously injected mixture of fuel and water to a stream selected from the group consisting of liquid water, supercritical water, fuel and the mixture of fuel and water.

18. The combustion system of claim 17, wherein the means for transferring heat is at a conduit extending from the compressor to the combustor.

19. The combustion system of claim 17, wherein the means for transferring heat is at a conduit extending from the combustor to the power turbine.

20. The combustion system of claim 17, wherein the means for transferring heat is at an exhaust gas conduit extending from the power turbine.

21. The combustion system of claim 16, wherein said means for heating the stream of water includes means for transferring heat from combustion of a previously injected mixture of fuel and water to a stream selected from the group consisting of water, fuel and the mixture of fuel and water.

22. The combustion system of claim 21 wherein said means for transferring heat can transfer heat to the fuel stream and the water stream.

23. The combustion system of claim 21 wherein the means for transferring heat is selected from the group consisting of finned tube and screw fin tube heat exchanger.

24. The combustion system of claim 21, wherein the means for transferring heat can conduct heat from the combustor to the mixture of fuel and water.

25. The combustion system of claim 21 wherein the means for transferring heat can conduct sufficient heat to raise the temperature of the mixture of fuel and water to at least the critical temperature of the mixture.

26. The combustion system of claim 21 wherein the means for transferring heat can extract sufficient heat to raise the temperature of the mixture of fuel and water to a temperature of at least about 373° C. (705° F.).

27. The combustion system of claim 21 wherein the means for transferring heat can extract sufficient heat to raise the temperature of the mixture of fuel and water to a temperature at least the greater of about 250° C. (482° F.) and the boiling temperature of water at the mixture pressure.

28. The combustion system of claim 21 further including a supplemental heating device and wherein the means for transferring heat, together with heat provided by said supplemental heating device can transfer sufficient heat, to raise the temperature of the mixture of fuel and water to a temperature of at least about 373° C. (705° F.).

29. The combustion system of claim 21 further including a fuel source and a water source.

30. The combustion system of claim 21 wherein said fuel is selected from the group consisting of #1 (kerosene), #2 (diesel), #6 (residual) and gasoline.

31. A combustion system, comprising:
a) a diesel engine;
b) means for heating and pressurizing a stream of water to a temperature of at least about 260° C. (500° F.) and a pressure of at least about 150 psig (10.2 atmospheres gauge) to thereby form a heated and pressurized stream of water;
c) means for combining the stream of heated water with a fuel stream, said means including a fuel stream having a temperature less than about 177° C. (350° F.) at a point of combination with the heated water, to thereby form a mixture of fuel and water; and
d) means for directing said mixture to the diesel engine for combustion.

32. The combustion system of claim 31, wherein said stream of water is in the liquid or supercritical state.

33. The combustion system of claim 31, wherein said diesel engine has an exhaust conduit and wherein said means for transferring heat is thermally integral with said exhaust conduit and extracts heat therefrom.
